(19) United States
(12) Patent Application Publication
(10) Pub. No.: US 2010/0313240 A1
(43) Pub. Date: Dec. 9, 2010

(54) AUTHENTICATION SYSTEM AND METHOD BETWEEN SERVER AND CLIENT

(76) Inventors: Sounghyun Kim, Daejeon (KR); Soohyung Kim, Daejeon (KR); Jonghyouk Noh, Daejeon (KR); Daosoon Choi, Daejeon (KR); Sangrao Cho, Daejeon (KR); Youngsoob Cho, Daejeon (KR); Sounghun Jin, Daejeon (KR)

Correspondence Address: STAAS & HALSEY LLP, SUITE 700, 1201 NEW YORK AVENUE, N.W., WASHINGTON, DC, 20005, US

(21) Appl. No.: 12/745,395

(22) PCT Filed: Oct. 16, 2008
(86) PCT No.: PCT/KR08/06093

§ 371 Date: May 28, 2010

(30) Foreign Application Priority Data
Nov. 29, 2007 (KR) 10-2007-0122688

(51) Int. Cl. G06F 21/00

(52) U.S. Cl. 726/3

(57) ABSTRACT

The present invention relates to an authentication system and method between a server and a client. The same authentication method is provided regardless of authentication media or authentication mechanisms, by displaying a universal authentication list that is obtained by requesting a universal authentication list to an authentication server by an authentication client, generating an authentication request message by using an authentication method selected by a user and sending the authentication request message to an authentication server, verifying the authentication request message received from the authentication client by the authentication server in order to decide whether the user is authenticated or not, and sending a response message to the authentication client.

### TECHNICAL FIELD

The present invention relates to an authentication system and method between a server and a client, and more particularly, to an authentication system and method between a server and a client that performs authentication between a server and a client by using various authentication media.

This work was supported by the IT R&D program of MIC/IITA [2007-S-601-01, User Control Enhanced Digital Identity Wallet System].

### BACKGROUND ART

There is an SASL (Simple Authentication and Security Layer) as a general method for universal authentication. The SASL supports various authentication mechanisms, such as CRAM-MD5, PLAIN, and GSSAPI, and provides a single use interface for processing the various authentication mechanisms. When authentication mechanisms supported by a client are sent to a server, the server designates one authentication mechanism and the client generally performs an authentication process for logging in the server by using the authentication mechanism. It is possible to obtain detailed information on SASL from Internet Engineering Task Force (IETF) draft standard RFC 2222 (Request For Comments).

The SASL has a drawback in that the authentication mechanism designated by the server should necessarily be followed. Further, it is not possible to know the reason why the authentication mechanism designated by the server should necessarily be followed, and a specific authentication mechanism should be followed regardless of the work that is performed in the server by the user. Furthermore, the SASL can manifest the authentication mechanism, but cannot manifest the authentication medium.

As a typical authentication method used in the related art, there is a method that agrees about the authentication of the use of an AKA (Authentication and Key Acknowledgement) mechanism between a server and a client and exchanges authentication request messages based on user information, thereby forming a communication channel.

When the authentication method is applied to a 3G communication system, an authentication process is performed in an USIM (Universal Subscriber Identity Module) that is a client of the AKA mechanism. In this case, the AKA mechanism is included as one authentication mechanism to which the SASL is applied, and an AKA authentication mechanism is applied through an interface provided by the SASL. In particular, when the AKA mechanism is operated in a smart card, the AKA mechanism is called SASL-AKA.

In the above-mentioned authentication method in the related art, an AKA mechanism is provided as one authentication mechanism that follows the operation mechanism of an existing SASL and is supported by the SASL. For this reason, the client should necessarily follow the authentication method proposed by the server. Further, services supporting universal authentication represent various authentication mechanisms, but the server determines one of the authentication methods that are supported by the client. For this reason, there are problems in that the method should be followed in order to make a user be authenticated in the server and only a passive authentication method capable of not being selected by a user is provided.

### DISCLOSURE OF INVENTION

1. Technical Problem

The present invention has been made to solve the above-mentioned problem, and it is an object of the present invention to provide an authentication system and method between a server and a client that provides the same authentication method in a server/client environment regardless of authentication media or authentication mechanisms and can select an authentication method corresponding to an authority level requested from a server by a user.

In the present invention, when a server sends a list of authentication media and authentication mechanisms supported by the server to a client, the client selects an authentication medium and an authentication mechanism according to user's selection and sends a universal authentication request message. In the related art, there is a protocol that provides services regardless of authentication mechanisms. However, according to the present invention, since specification of various authentication media and authentication mechanisms is manifested in a single format, detailed authentication levels are supported.

Further, the present invention provides a method and system that can select an authentication method corresponding to an authority level requested from a server by a user.

2. Technical Solution

According to an aspect of the present invention, an authentication system includes a client and an authentication server. The client requests a universal authentication list to the authentication server, obtains the universal authentication list, displays the universal authentication list in order to provide the universal authentication list to a user, generates an authentication request message by using an authentication method selected by the user, and sends the authentication request message to the authentication server. The authentication server receives a request of the universal authentication list from the client, sends a supportable universal authentication list to the client, verifies the authentication request message received from the client in order to decide whether the user is authenticated or not, and transmits a response message to the client.

When the client displays the universal authentication list, the client may display at least one of the scopes of authorities that can be obtained from the authentication server when an authentication medium, an authentication mechanism, and each authentication method are selected.

The authentication server may decide whether the user is authenticated or not, by performing a verification process for confirming whether the authentication request message received from the client is included in an authentication list of the authentication server.

According to another aspect of the present invention, an authentication client requests a universal authentication list to an authentication server in order to obtain the universal authentication list, displays the obtained universal authentication list in order to provide the obtained universal authentication list to a user, generates an authentication request message by using an authentication method selected by the user, and sends the authentication request message to the authentication server.

The authentication client may include an authentication medium list inquiring and selecting unit, an authentication medium list obtaining unit, and a universal authentication executing unit. The authentication medium list inquiring and selecting unit displays the universal authentication list received from the authentication server and receives an authentication medium list input by the user. The authentication medium list obtaining unit extracts a universal authentication list from a universal authentication message that is received from the authentication server. The universal authentication executing unit loads an authentication medium, which is manifested in a universal authentication method selected by the user, from a storage unit, and applies an authentication mechanism by using the authentication medium during the generation of the universal authentication message.

The authentication client may further include a universal authentication message generating and verifying unit that generates a message to be sent to the authentication server and verifies the message received from the authentication server.

According to another aspect of the present invention, an authentication server receives a request of a universal authentication list from an authentication client, sends a supportable universal authentication list to the authentication client, verifies an authentication request message received from the authentication client in order to decide whether a user is authenticated or not, and transmits a response message to the authentication client.

The authentication server may further include a universal authentication message generating and verifying unit, a universal authentication executing unit, and an authentication information generating and verifying unit. The universal authentication message generating and verifying unit generates a message to be sent to the authentication client, and verifies the message received from the authentication client. The universal authentication executing unit registers universal authentication information on the basis of the message received from the authentication client, or authenticates a user by using the registered universal authentication information. The authentication information generating and verifying unit decides whether the user is authenticated or not, by using the universal authentication information that is previously registered through the authentication client by the user.

According to another aspect of the present invention, a universal authentication method includes requesting a universal authentication list by an authentication client; receiving a supportable universal authentication list from an authentication server which received the request of the universal authentication list from the authentication client by the authentication client; displaying the received universal authentication list by the authentication client; generating an authentication request message by using an authentication method, which is selected by a user, by the authentication client in order to send the authentication request message to the authentication server; and receiving a response message from the authentication server by the authentication client which verified the authentication request message and decided whether the user is authenticated or not.

The displaying of the received universal authentication list may include displaying the scope of an authority that can be obtained from the authentication server when each authentication method is selected.

The requesting of the universal authentication list by the authentication client may be performed when the universal authentication list is not retained during the driving of the authentication client.

When the response message about the authentication, which is received from the authentication server, includes a state message requiring an additional authentication process, the authentication client may repeat displaying the received universal authentication list and sending the authentication request message to the authentication server.

### ADVANTAGEOUS EFFECTS

According to the present invention, since specification of various authentication media and authentication mechanisms is manifested in a single format, the same authentication method capable of supporting detailed authentication levels is provided regardless of authentication media or authentication mechanisms. Therefore, unlike the authentication process of a client where an authentication method determined by a server should be followed, it is possible to select an authentication method corresponding to an authority level requested from a server by a user.

Further, while sending an authentication method supported by the server to a client, a server provides explanation of an authority that can be obtained through the authentication method by a user. Therefore, before selecting an authentication medium and an authentication mechanism, the user can examine an authority that can be obtained through the method. As a result, a user can agree about an authentication medium and an authentication mechanism that are used to obtain a desired authority from a server.

### BRIEF DESCRIPTION OF THE DRAWINGS

FIG. 1 is a schematic view illustrating a universal authentication process according to a preferred embodiment of the present invention.

FIG. 2 is a block diagram of a client and a server, which are used in universal authentication according to the present invention.

FIG. 3 is a flowchart illustrating the specific operation of the universal authentication process in a universal authentication client according to the present invention.

### BEST MODE FOR CARRYING OUT THE INVENTION

A preferred embodiment of the present invention will be described below with reference to accompanying drawings.

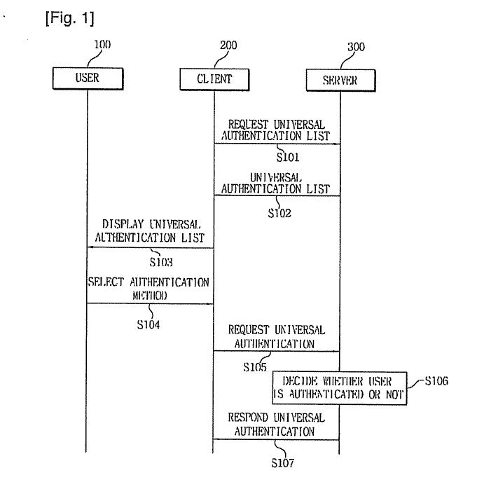

FIG. 1 is a schematic view illustrating a universal authentication process according to a preferred embodiment of the present invention.

A universal authentication system according to the present invention includes a user 100, a universal authentication client 200, and a universal authentication server 300. FIG. l shows an authentication process therebetween.

Referring to FIG. 1, when a universal authentication client 200 requests a universal authentication list to a universal authentication server 300, the universal authentication service starts (Step S101). If the universal authentication server 300 sends a universal authentication list, which is supported by the universal authentication server, to the universal authentication client 200 (Step S102), the universal authentication client 200 displays the universal authentication list to provide the universal authentication list to the user 100 (Step S103). In this case, the user can confirm description about the scope of an authority, which can be obtained from the universal authentication server 300 when each authentication method is selected, as well as information about an authentication medium and an authentication mechanism. If the user 100 selects an appropriate authentication method in order to obtain an authority corresponding to a desired level (Step S104), the universal authentication client 200 generates a universal authentication request message by using the authentication method selected by the user 100 and sends the universal authentication request message to the universal authentication server 300 (Step S105). The universal authentication server 300 verifies the universal authentication request message in order to decide whether the user is authenticated or not (Step S106), and returns a response message corresponding to the decision to the universal authentication client 200 (Step S107), which ends a universal authentication service.

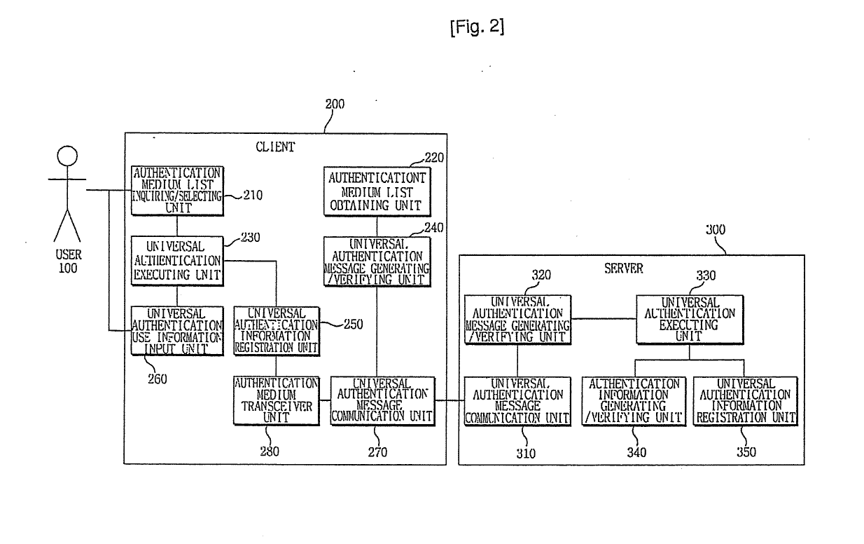

FIG. 2 is a block diagram of a client and a server, which are used in universal authentication according to the present invention.

Universal authentication service architecture, which provides the same authentication method in a server/client environment regardless of authentication media or authentication mechanisms, according to a preferred embodiment of the present invention will be described in detail below with reference to FIG. 2.

Examples of a subject related to a universal authentication service between a server and a client, which uses various authentication media, may include a user 100, a universal authentication client 200, and universal authentication server 300.

The user 100 performs an authentication process of the universal authentication server 300 by the universal authentication client 200. The user 100 selects an authentication method by using the authentication medium registered on the universal authentication client 200, and inputs additional information if necessary.

The universal authentication client 200 includes an authentication medium list inquiring and selecting unit 210, an authentication medium list obtaining unit 220, a universal authentication executing unit 230, a universal authentication message generating and verifying unit 240, a universal authentication information registration unit 250, a universal authentication use information input unit 260, a universal authentication message communication unit 270, and an authentication medium transceiver unit 280.

The authentication medium list inquiring and selecting unit 210 displays a universal authentication list, and user's selection is input to the authentication medium list inquiring and selecting unit. The universal authentication list basically indicates the combination of the authentication medium and the authentication mechanism. In addition, the authentication medium list inquiring and selecting unit displays the authority list, which can be obtained when corresponding universal authentication method is used, so that a user can refer to the authority list in order to select a universal authentication method.

The authentication medium list obtaining unit 220 extracts the universal authentication list from the universal authentication message that is received from the universal authentication server.

The universal authentication executing unit 230 loads an authentication medium, which is manifested in the universal authentication method selected by the user, from a storage unit. Further, the universal authentication executing unit applies the authentication mechanism by using the authentication medium during the generation of the universal authentication message. In this case, the storage unit in which various authentication media are stored may be provided inside the client 200 or may be provided outside the client 200.

The universal authentication message generating and verifying unit 240 generates a message to be sent to the universal authentication server 300, and verifies the message received from the universal authentication server 300.

The universal authentication information registration unit 250 registers an authentication medium that is to be used for a universal authentication service by a user.

Security information, which is additionally required when the universal authentication client 200 has access to the authentication medium in order to perform corresponding operation, is input to the universal authentication use information input unit 260.

The universal authentication message communication unit 270 exchanges messages on the basis of a protocol that is predetermined by the universal authentication server 300 and the client 200. Existing message level security and transmission level security may be used for the purpose of safe message exchange.

If an authentication medium to be used for the universal authentication service is provided outside the universal authentication client 200, the authentication medium transceiver unit 280 obtains the authentication medium and brings the authentication medium to the universal authentication client 200. Further, when a user intends to transfer the authentication medium stored in the universal authentication client system to a storage unit provided outside, the authentication medium transceiver unit sends the authentication medium to an external storage unit.

Meanwhile, the universal authentication server 300 includes a universal authentication message communication unit 310, a universal authentication message generating and verifying unit 320, a universal authentication executing unit 330, an authentication information generating and verifying unit 340, and a universal authentication information registration unit 350.

The universal authentication message communication unit 310 exchanges messages with the client 200 on the basis of a protocol that is predetermined by the universal authentication server 300 and the client 200. Existing message level security and transmission level security may be used for the purpose of safe message exchange.

The universal authentication message generating and verifying unit 320 generates a message to be sent to the universal authentication client 200, and verifies the message received from the universal authentication client 200.

The universal authentication executing unit 330 registers universal authentication information on the basis of the message received from the universal authentication client 200, or authenticates a user by using the registered universal authentication information.

The authentication information generating and verifying unit 340 decides whether the user is authenticated or not, by using the universal authentication information that is previously registered on the universal authentication server 300 through the universal authentication client 200 by the user.

When the user joins the universal authentication server 300 by using the universal authentication client 200, the universal authentication information registration unit 350 registers universal authentication information, which is to be used later during an authentication process, on the universal authentication server 300.

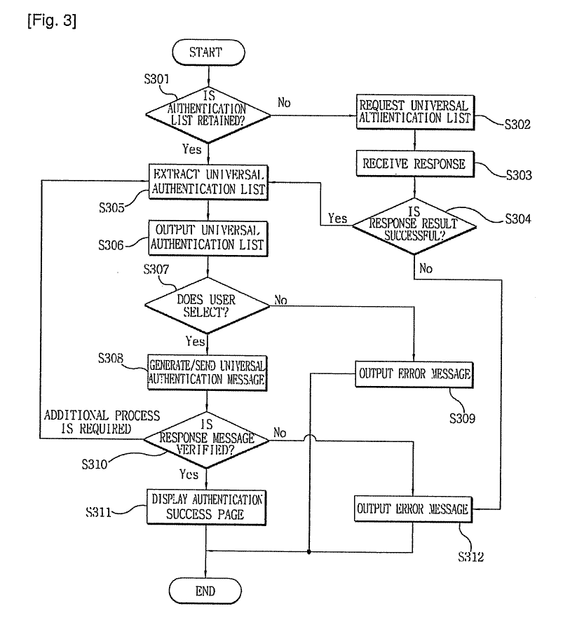

FIG. 3 is a flowchart illustrating the specific operation of the universal authentication process in a universal authentication client according to the present invention.

A method, which provides the same authentication method in a server/client environment regardless of authentication media or authentication mechanisms, according to an embodiment of the present invention will be described in detail with reference to FIG. 3.

The universal authentication client 200, which is driving, extracts a universal authentication list. First, the universal authentication client checks whether the universal authentication list is retained or not (Step S301). If the universal authentication list is not retained (No in S301), the universal authentication client makes a request for the universal authentication list to the universal authentication server 300 (Step S302). After receiving the request, the universal authentication server 300 returns “True” state information and the universal authentication list that is supported by the universal authentication server. If a request message has an error or a problem is generated in the universal authentication server, a response message returns “False” state information.

The universal authentication client 200 receives a response message from the universal authentication server 300 (Step S303), and verifies the state information of the received response message (Step S304). If the universal authentication client successfully brings a universal authentication list from the universal authentication server 300 (Yes in S304), the universal authentication client extracts the universal authentication list (Step S305). If the universal authentication client does not successfully bring a universal authentication list from the universal authentication server (No in S304), the universal authentication client outputs an error message and ends the process (Step S312).

If the universal authentication client 200 previously includes a universal authentication list while being driven (Yes in S301), the process proceeds to Step S305 and the universal authentication client extracts the universal authentication list. The universal authentication client 200 outputs the universal authentication list, and displays the universal authentication list to a user (Step S306). In this case, a picture displayed to the user may be formed in various ways. Alternatively, an authority, which can be obtained when the authentication method is performed, may be displayed as well as the universal authentication list supported by the server.

If the user selects one from the universal authentication list (Yes in S307), a universal authentication request message is generated by the authentication method and transmitted to the universal authentication server 300 (Step S308). Additional user's input may be required to generate a message. If the user abandons the selection in Step S307 or makes an error in an additional user's input step (No in S307), the universal authentication client 200 outputs an error message and ends the process (Step S309).

The universal authentication request message generated by the universal authentication client 200 is transmitted to the universal authentication server 300 and is subject to an authentication process. The universal authentication client 200, which receives the result of the authentication process from the universal authentication server 300, verifies a response message (Step S310). In this case, when an additional authentication process such as Two-Factor authentication is required, the universal authentication server 300 returns the response message and the universal authentication list to the universal authentication client 200. When receiving the response message, the universal authentication client 200 again performs a universal authentication process (Step S305).

If the universal authentication request message sent by the universal authentication client 200 is successfully verified, the universal authentication server 300 returns a “True” state message and a universal authentication completion picture. When receiving the message, the universal authentication client 200 displays an authentication success page (Step S311). When errors occur in the universal authentication request message sent by the universal authentication client 200, the universal authentication server 300 returns a “False” state message and an error message. In this case, the universal authentication client 200 receiving the error message outputs the error message (Step S312).

1. An authentication system comprising:
a client that requests a universal authentication list to an authentication server, obtains the universal authentication list, displays the universal authentication list in order to provide the universal authentication list to a user, generates an authentication request message by using an authentication method selected by the user, and sends the authentication request message to the authentication server; and
an authentication server that receives a request of the universal authentication list from the client, sends a supportable universal authentication list to the client, verifies the authentication request message received from the client in order to decide whether the user is authenticated or not, and transmits a response message to the client.

2. The authentication system according to claim 1,
wherein when the client displays the universal authentication list, the client displays at least one of scopes of authorities that can be obtained from the authentication server when an authentication medium, an authentication mechanism, and each authentication method are selected.

3. The authentication system according to claim 1,
wherein the authentication server decides whether the user is authenticated or not, by performing a verification process for confirming whether the authentication request message received from the client is included in an authentication list of the authentication server.

4. An authentication client that requests authentication to an authentication server, the authentication client requesting a universal authentication list to the authentication server in order to obtain the universal authentication list, displaying the obtained universal authentication list in order to provide the to provide the obtained universal authentication list to a user, generating an authentication request message by using an authentication method selected by the user, and sending the authentication request message to the authentication server.

5. The authentication client according to claim 4, comprising:
an authentication medium list inquiring and selecting unit that displays the universal authentication list received from the authentication server and receives an authentication medium list input by the user;
an authentication medium list obtaining unit that extracts a universal authentication list from a universal authentication message, the universal authentication message being received from the authentication server; and
a universal authentication executing unit that loads an authentication medium, which is manifested in a universal authentication method selected by the user, from a storage unit, and applies an authentication mechanism by using the authentication medium during the generation of the universal authentication message.

6. The authentication client according to claim 4,
wherein the universal authentication list includes at least one of an authentication medium and an authentication mechanism.

7. The authentication client according to claim 6,
wherein the universal authentication list further includes the scope of an authority that can be obtained from the authentication server when each authentication method is selected.

8. The authentication client according to claim 5, further comprising:
a universal authentication message generating and verifying unit that generates a message to be sent to the authentication server, and verifies the message received from the authentication server.

9. An authentication server characterized in that receives a request of a universal authentication list from an authentication client, sends a supportable universal authentication list to the authentication client, verifies an authentication request message received from the authentication client in order to decide whether a user is authenticated or not, and transmits a response message to the authentication client.

10. The authentication server according to claim 9, comprising:
a universal authentication message generating and verifying unit that generates a message to be sent to the authentication client, and verifies the message received from the authentication client;
a universal authentication executing unit that registers universal authentication information on the basis of the message received from the authentication client, or authenticates a user by using the registered universal authentication information; and
an authentication information generating and verifying unit that decides whether the user is authenticated or not, by using the universal authentication information that is previously registered through the authentication client by the user.

11. A universal authentication method comprising:
an authentication client requesting a universal authentication list;
the authentication client receiving a supportable universal authentication list from an authentication server which received the request of the universal authentication list from the authentication client;
the authentication client displaying the received universal authentication list;
the authentication client generating an authentication request message by using an authentication method, which is selected by a user in order to send the authentication request message to the authentication server; and
the authentication client receiving a response message from the authentication server which verified the authentication request message and decided whether the user is authenticated or not.

12. The universal authentication method according to claim 11,
wherein the displaying of the received universal authentication list includes displaying the scope of an authority that can be obtained from the authentication server when each authentication method is selected.

13. The universal authentication method according to claim 11,
wherein the requesting of the universal authentication list by the authentication client is performed when the universal authentication list is not retained during the driving of the authentication client.

14. The universal authentication method according to claim 11,
wherein when the response message about the authentication, which is received from the authentication server, includes a state message requiring an additional authentication process, the authentication client repeats displaying the received universal authentication list and sending the authentication request message to the authentication server.
